(19) United States
(12) Patent Application Publication
(10) Pub. No.: US 2026/0291992 A1
(43) Pub. Date: Sep. 24, 2026

(54) PROFILING APPLICATIONS VIA NETWORK BEHAVIOR

(71) Applicant: Netskope, Inc., Santa Clara, CA (US)

(72) Inventors: Dagmawi Mulugeta, London (GB); Colin Davidson Estep, Vienna, VA (US); Raymond Joseph Canzanese, JR., Philadelphia, PA (US); Siying Yang, Saratoga, CA (US)

(21) Appl. No.: 19/388,218

(22) Filed: Nov. 13, 2025

Related U.S. Application Data
(60) Provisional application No. 63/775,883, filed on Mar. 21, 2025.

(51) Int. Cl. H04L 9/40; H04L 69/22

(52) U.S. Cl. CPC H04L 63/20; H04L 63/1416; H04L 69/22

(57) ABSTRACT

A network security system is disclosed for detecting anomalies in network traffic by evaluating behavioral characteristics of communications attributed to specific applications. The system intercepts Hypertext Transfer Protocol (HTTP) and HTTP Secure (HTTPS) traffic transmitted between endpoint devices and destination domain servers and extracts header information including user-agent information from each request and response. A profiling engine attributes each communication to an application based on the user-agent information and batches communications according to the application, originating endpoint, and time window. The profiling engine applies an application-specific classifier model trained on a behavioral profile for the application to detect deviations from expected network behavior. Deviations may indicate either malware that falsely advertises itself as a benign application or a legitimate application that has been compromised. A security policy enforcer applies one or more security policies to future traffic associated with the affected application or endpoint device based on the classification result.

### CROSS REFERENCE TO RELATED APPLICATIONS

This application claims the benefit of and priority to U.S. Provisional Patent Application No. 63/775,883, titled “PROFILING APPLICATIONS VIA NETWORK BEHAVIOR,” filed Mar. 21, 2025, the contents of which is hereby incorporated by reference in its entirety for all purposes.

### BACKGROUND

Malicious software (i.e., malware) is used by cybercriminals to harm legitimate people and businesses in many ways including interrupting public services, stealing data (e.g., confidential, and secure data such as personally identifying information), and stealing financial resources. Cybercriminals and malware are an ever-present issue for any entity utilizing computing technology. Two particularly difficult types of threats to detect include compromised third-party applications (e.g., SOLARWINDS® compromise in 2020) and malicious applications masquerading as different (e.g., known benign) applications.

Existing commercial solutions attempt to identify compromised applications' network traffic using various techniques including source code controls to identify malicious code entries by developers, supply chain security tools that scan for outdated and vulnerable third-party libraries and potentially compromised ones, intrusion protection systems that identify and block live network traffic that matches signatures of known malicious traffic, and endpoint detection and response platforms that identify potentially malicious traffic by matching patterns of known malicious process execution and network communication.

However, these techniques do not adequately identify the two threats discussed above. Accordingly, improvements are needed.

### SUMMARY

Disclosed herein are techniques for providing a profiling engine (i.e., detector) that identifies two types of particular types of malicious threats: (1) third-party applications that have been compromised (e.g., SOLARWINDS® 2020) and (2) malware that is falsely advertising itself as a benign application (e.g., EMOTET).

Both of these threats will attempt to blend into existing network traffic to avoid being spotted by various network and enterprise security systems. In the case of (1) compromised third party applications, malicious attackers abuse trusted infrastructure to retrieve commands and pilfer sensitive information. In the case of (2) malware, threat actors typically change (i.e., falsify) user-agent header values to match a popular application (e.g., CHROME® or FIREFOX® browsers) to blend into existing traffic.

Most organizations cannot afford to have a network security engineer constantly looking for malicious activity in packet captures to identify these threats. Accordingly, companies instead detect (1) supply chain compromises via provenance checks along different stages of the software supply chain (i.e., compromised third-party applications) and (2) malware compromises through signatures and heuristics that detect patterns in known malicious traffic.

The methods and systems disclosed herein provide new techniques to reliably detect (1) supply chain compromises/compromised third-party applications and (2) malware from HyperText Transfer Protocol (HTTP) and HTTP Secure (HTTPs) traffic. In some embodiments, a network security system employing the disclosed techniques is interposed between endpoint devices and destination domain servers. The system intercepts network traffic between the endpoint devices and the destination domain servers and extracts header information, including user-agent information, from each HTTP request and response of the network traffic. From the header information, the system identifies an originating application for the communications.

A profiling engine the network security system batches a subset of the HTTP traffic based on the identified application, an originating endpoint device, and an associated time window, and applies an application-specific classifier model trained to recognize deviations in network behavior. The classifier model compares the extracted header and user-agent information of the subset to a behavioral profile corresponding to the identified application to generate an anomaly classification. Based on the anomaly classification, a security policy enforcer of the network security system may then apply or modify security policies governing future HTTP traffic associated with endpoint device, application, or a combination thereof.

### BRIEF DESCRIPTION OF THE DRAWINGS

Many aspects of the disclosure can be better understood with reference to the following drawings. The components in the drawings are not necessarily drawn to scale.

Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a security environment including a network security system that detects malware using profiling, according to some embodiments.

FIG. 2 illustrates a detection method according to some embodiments.

FIG. 3 illustrates an example request header information including user-agent information, according to some embodiments.

FIG. 4 illustrates an example output from a user-agent parser, according to some embodiments.

FIG. 5 illustrates example prompt and response used to identify a user-agent type with a generative artificial intelligence model, according to some embodiments.

FIGS. 6A and 6B illustrate sets of user-agent information and corresponding behaviors, including a set indicating malware presenting by misadvertising, according to some embodiments.

FIG. 7 illustrates a set of user-agent information and corresponding behaviors indicating well-defined behavior, according to some embodiments.

FIG. 8 illustrates information regarding an example dataset used to train the malware profiling models, according to some embodiments.

FIGS. 9A and 9B illustrate an example heat map and associated performance data for a misadvertising profiling model, according to some embodiments.

FIG. 10 illustrates example performance data for an application model, according to some embodiments.

FIG. 11 illustrates an example graph of feature vector elements and corresponding values for a transaction from a non-compromised application and for a compromised application analyzed by an application profiling model, according to some embodiments.

FIG. 12 illustrates an example computing system, according to some embodiments.

### DETAILED DESCRIPTION

Disclosed are methods and systems that provide approaches for accurately identifying applications and detecting anomalies in corresponding network behavior without requiring installation of endpoint agents. In some embodiments, a system employing the disclosed techniques extracts insights about the behavior of an application from observed Hypertext Transfer Protocol (HTTP) and HTTP Secure (HTTPS) traffic transmitted between endpoint devices and destination domain servers. In operation, the network security system intercepts this traffic and analyzes header information, including user-agent information contained in HTTP requests and responses, to attribute each communication to an originating application. The attributed communications are batched by the profiling engine according to the identified application, a corresponding endpoint device, and a time window associated with the communications. From each batch, the profiling engine extracts a plurality of signals that together form a feature vector representing the network behavior of the application over that period. The feature vector is then submitted to an application-specific classifier model stored in a model data store and previously trained to identify deviations from a pre-identified behavioral profile corresponding to the application. When such deviations are detected, the profiling engine generates an anomaly classification that is provided to a security policy enforcer, which may apply or modify security policies for future traffic associated with the affected application or endpoint device.

In some embodiments, the disclosed techniques further include leveraging machine learning models that accurately identify applications (i.e., attribute HTTP traffic to applications). In such embodiments, the network security system extracts insights about the behavior of an application from network traffic data by analyzing in excess of fifty-six billion HTTP/HTTPS transactions gathered from thousands of organizations worldwide. With this information, the system then builds behavioral models corresponding to each identified application. In some cases, a given classifier model may be trained specifically on the extracted insights for a given application and stored in a model data store for later use. In any case, once the behavioral models are configured, the system can intercept new network traffic, extract header information from the new traffic, interpret user-agent strings of the network traffic to identify originating applications for the new traffic, and apply the appropriate behavior model to new traffic in order to detect (1) compromised third-party applications and (2) malware masquerading as benign applications.

In some embodiments, a system employing the disclosed techniques further leverages generative artificial-intelligence (GAI) models and open-source libraries to interpret user-agent strings and attribute the associated network traffic to respective applications. Problematically, user-agent headers do not have a standard and are particularly unstructured. Traditional attempts to parse user-agent headers in order to understand and make practical use of all the different values therein do not achieve sufficient accuracy. However, with the addition of GAI models to parse the unstructured nature of the user-agent header, the disclosed network security systems have an improved ability to more accurately attribute a user-agent string to an application.

In some embodiments, a system employing the disclosed techniques extracts more than one-hundred and eighty-five signals from application-specific network traffic in order to construct a comprehensive behavior profile for each relevant application of the network traffic. For example, these signals may include:
(a) Hostnames that are reached out to by the application.
(b) How much of the application's traffic is referred?
(c) What HTTP methods are typically used? What are the HTTP statuses?
(d) How long do requests and responses take? How much data is sent?
(e) How much of the traffic is going to the known cloud provider domain?
(f) Nature and quantity of the JA3 transport layer security fingerprints.
(g) What are the HTTP request and response content types?
(h) What file types are being uploaded and downloaded?
(i) Sequences or notable patterns that are prominent for the application.

Based on the extracted signals, for which the list above provides examples, a system employing the disclosed techniques is able to configure behavioral profiles for a variety of applications, such as browsers and native applications. Examples of such applications include GOOGLE CHROME®, FIREFOX®, SLACK®, SPOTIFY®, CURL®, and the like. The system is then able to use the behavioral profiles to interrogate new network traffic. For example, such interrogations may investigate the following for the new network traffic:
(a) What does the user agent advertise as the network traffic's source?
(b) How does the traffic compare to a relevant behavioral profile?
(c) Does the behavioral profile match what is advertised for the traffic?

In some embodiments, the disclosed techniques may be implemented such that the efficacy of the profiling engine and associated classifier models can be evaluated during operation. For example, in such embodiments, experiments may be conducted that demonstrate the ability of a system employing the disclosed techniques to detect both (1) malware and (2) compromised third-party applications. For the malware detection case (i.e., scenarios where malware misadvertises itself as originating from a trusted application), the system may be implemented to include a random-forest classification architecture capable of achieving approximately ninety-five percent accuracy for detecting command-and-control communication when tested against more than fifteen-thousand hours of traffic from popular command-and-control frameworks including COBALT STRIKE®, Sliver, METASPLOIT®, BRUTE RATEL, and MYTHIC. For the compromised-application case, the system may be implemented to include a random-forest classification architecture capable of the models identified anomalous transactions indicative of supply-chain compromise with up to ninety percent accuracy, and as high as ninety-nine percent for applications that express relatively predictable (e.g., highly consistent) behavioral patterns. Here, the random-forest classifier accurately identified anomalous requests that did not originate from well-known applications, demonstrating the system's ability to distinguish legitimate application traffic from compromised behavior.

The disclosed system provides several technical effects or benefits that substantially improve the reliability and depth of network-based threat detection. For example, the system is difficult to circumvent because it detects network traffic that attempts to blend in with benign traffic. Further, the system uses behavioral signals derived directly from network communications, representing the ground truth of application behavior rather than relying on source-code analysis or endpoint instrumentation. The system also enables detection of compromised applications that begin communicating with new or previously unseen hosts, a behavior that was previously nearly impossible to identify using conventional techniques.

Because the profiling engine attributes communications based on user-agent information and then compares the attributed traffic to a behavioral profile, simple user-agent substitution (i.e., misadvertising) cannot conceal malicious activity. For example, malware that modifies its user-agent header to identify as “Chrome” (CHROME®) or “Firefox” (FIREFOX®) produces network patterns, such as limited host diversity, minimal referrers, and repetitive request sequences, that do not align with the behavioral profile of an actual browser. When such discrepancies are detected, the classifier model generates an anomaly classification, thereby identifying traffic that would otherwise appear benign to conventional signature-based systems.

Further, the classifier models operate on signals derived from real network behavior, providing a direct measurement of how applications interact with external servers. These signals include, for example, hostnames accessed, HTTP methods and statuses, and TLS fingerprints observed in live traffic. By modeling this behavioral layer instead of relying on static code artifacts, the system maintains effectiveness even when the underlying application binaries or codebases are modified, obfuscated, or encrypted. This provides a persistent ground truth that reflects the actual runtime behavior of each application.

When a legitimate application is compromised, it often begins contacting new command-and-control servers or exfiltration domains in addition to its expected hosts. The trained application model captures this deviation by identifying requests to new or uncharacteristic hostnames. For instance, an enterprise productivity application such as a document editor normally communicates with a defined set of cloud endpoints. If the same application suddenly initiates connections to external domains unrelated to its service, the classifier model flags the batch as anomalous and alerts the security policy enforcer, which can then isolate or block the affected endpoint. This capability allows near-real-time detection of compromises that would otherwise remain invisible within trusted network channels.

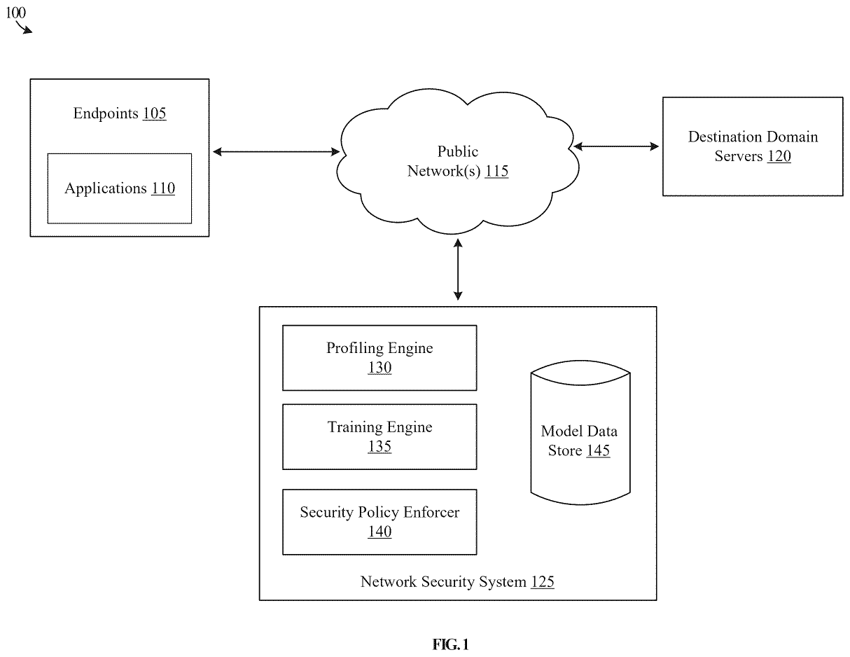

FIG. 1 illustrates a security environment 100 used to detect malware and compromised third party applications (collectively referred to herein as malicious software) in accordance with some embodiments. Security environment 100 includes network security system 125 with the features for detecting the malicious software as described throughout. Security environment 100 includes endpoints 105, public networks 115, destination domain servers 120, and network security system 125. Security environment 100 may include additional computing systems not shown here for ease of description. For example, more endpoints 105, more destination domain servers 120, other computing systems that access public network 115, and the like may be included.

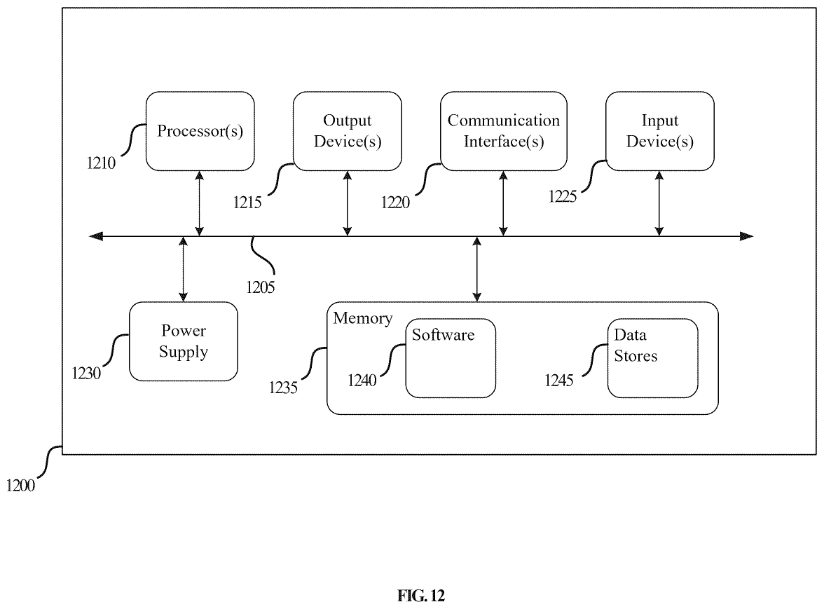

Endpoints 105 may be user devices including desktops, laptops, mobile devices, and the like. The mobile devices include smartphones, smart watches, and the like. Endpoints 105 may also include internet of things (IOT) devices. Endpoints 105 may include any number of components including those described with respect to computing device 1200 of FIG. 12 including processors, output devices, communication interfaces, input devices, memory, and the like, all not depicted here for clarity. Endpoints 105 may be used to access content (e.g., documents, images, and the like) stored in hosted services and other destination domain servers 120 and otherwise interact with servers and other devices connected to public network 115.

Endpoints 105 include applications 110. In some embodiments, an endpoint routing client is used to route network traffic over public network 115 from endpoints 105 to network security system 125 for endpoints 105 in an enterprise protected by network security system 125. In some embodiments, the endpoint routing client may be a client installed on endpoint 105. In other embodiments, the endpoint routing client may be implemented using a gateway that traffic from each endpoint 105 passes through for transmission out of a private or sub-network. While a single endpoint 105 is shown for simplicity, any number of endpoints 105 may be included in security environment 100. Further, multiple endpoints 105 associated each with one of a number of enterprises or clients of network security system 125 may be included. In some embodiments, a number of endpoints 105 associated with an enterprise may connect to a private network (not shown) that uses, for example, a gateway to access public network 115.

Applications 110 may be any applications installed on endpoints 105. Applications 110 may include, for example, browsers (e.g., GOOGLE CHROME®, SAFARI®, FIREFOX®, MICROSOFT EDGE®), and any other installed applications that may reach out to destination domain servers 120. For example, applications 110 may include a downloadable client installed on endpoints 105 such as, for example, client-side installed applications for BOX®, MICROSOFT OFFICE TOOLS, SKYPE®, SLACK®, SPOTIFY®, CURL®, and the like.

Applications 110 further include compromised third-party applications, which are created when a bad actor inserts code into one of the above described applications such as BOX®, SKYPE®, or SLACK® that uses the application to perform unwanted behaviors such as stealing data and the like while also performing the behaviors expected by the user. Applications 110 further include malware installed on endpoints 105 that masquerade as benign applications. The malware is often installed unwittingly by a user accessing an infected site, document, or other location on endpoint 105. The malware may execute behind the scenes to steal data or otherwise compromise security on endpoint 105 while attempting to blend into browser traffic by masquerading, for example, as a browser by modifying the user agent in the header.

Public network 115 may be any public network including, for example, the Internet. Public network 115 couples endpoints 105, destination domain servers 120, and network security system 125 such that any may communicate with any other via public network 115. While not depicted for simplicity, public network 115 may also couple many other devices for communication including, for example, other servers, other private networks, other user devices, and the like (e.g., any other connected devices). The communication path can be point-to-point over public network 115 and may include communication over private networks (not shown). Communications can occur using a variety of network technologies, for example, private networks, Virtual Private Network (VPN), multiprotocol label switching (MPLS), local area network (LAN), wide area network (WAN), Public Switched Telephone Network (PSTN), Session Initiation Protocol (SIP), wireless networks, point-to-point networks, star network, token ring network, hub network, Internet, or the like. Communications may use a variety of protocols. Communications can use appropriate application programming interfaces (APIs) and data interchange formats, for example, Representational State Transfer (REST), JavaScript Object Notation (JSON), Extensible Markup Language (XML), Simple Object Access Protocol (SOAP), Java Message Service (JMS), Java Platform Module System, and the like. Additionally, a variety of authorization and authentication techniques, such as username/password, Open Authorization (OAuth), Kerberos, SecureID, digital certificates and more, can be used to secure communications.

Destination domain servers 120 include any domain servers available on public network 115. Destination domain servers 120 may include, for example, hosted services such as cloud computing and storage services, financial services, e-commerce services, or any type of applications, websites, or platforms that provide cloud-based storage or web services. At least some destination domain servers 120 may provide or store documents that endpoints 105 access (e.g., store, manipulate, download, upload, open, or the like). Further, destination domain servers 120 include all hosted services with which applications 110 communicate (e.g., BOX® server, MICROSOFT OFFICE servers, SLACK® servers, and the like).

Network security system 125 may provide network security services to endpoints 105. An endpoint routing client may route traffic addressed to destination domain servers 120 from the endpoints 105 to network security system 125 to enforce security policies. Based on the security policy enforcement, the traffic may then be routed to the addressed destination domain server 120, blocked, modified, or the like. While network security system 125 is shown as connected to endpoints 105 via public network 115, in some embodiments, network security system 125 may be on a private network with endpoints 105 to manage network security on premises. Network security system 125 may implement security management for endpoints 105. The security management may include protecting endpoints 105 from various security threats and vulnerabilities including detecting malicious software as described herein. For simplicity, the features of network security system 125 related to detecting malicious software are shown while other security features are not described in detail. Network security system 125 may be implemented as a cloud-based service and accordingly may be served by one or more server computing systems that provide the cloud-based services that are distributed geographically across data centers, in some embodiments. Network security system 125 may be implemented in any computing system or architecture that can provide the described capabilities without departing from the scope of the present disclosure. Network security system 125 may include, among other security features, profiling engine 130, training engine 135, security policy enforcer 140, and model data store 145. While a single network security system 125 is depicted for simplicity, any number of network security systems 125 may be implemented in security environment 100 and may include multiple instances of profiling engine 130, training engine 135, security policy enforcer 140, and model data store 145 for handling multiple clients or enterprises on a per/client basis, for example.

Profiling engine 130 may be used for training and for analysis. In some embodiments, profiling engine 130 may have separate instances for training and for analysis.

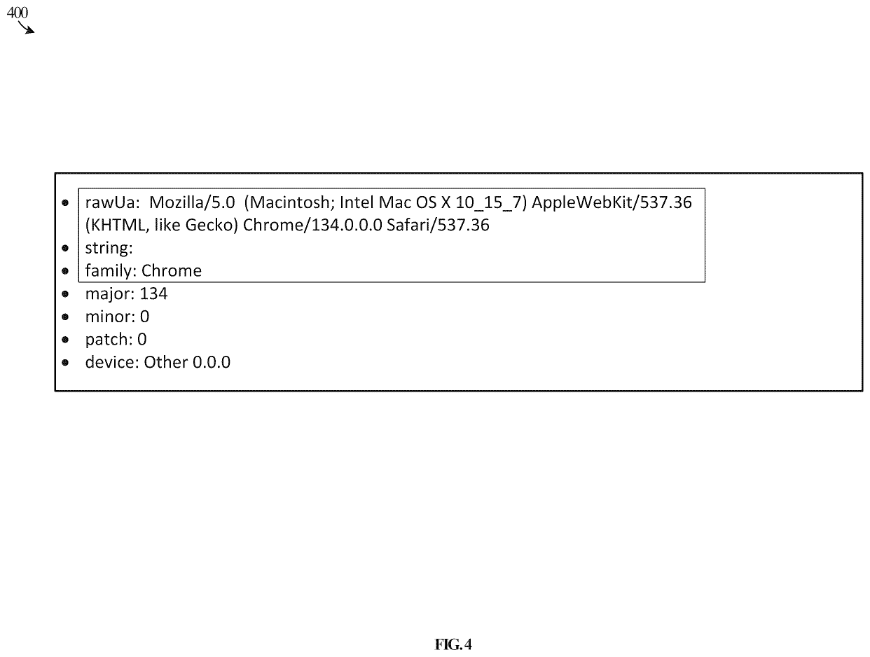

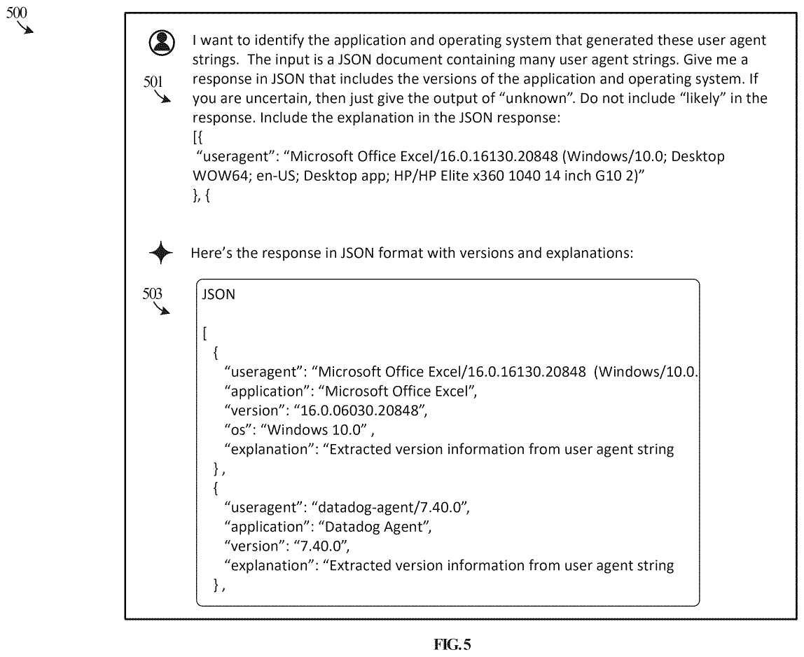

For either use, profiling engine 130 analyzes the user-agent information in the header of HTTP/HTTPS traffic to identify the associated application. For the purpose of brevity, “HTTP” as used herein may refer to either or both of HTTP traffic and HTTPS traffic. Profiling engine 130 may use user-agent parsers (e.g., Python libraries) that identify known user agents, which is discussed in more detail with respect to FIG. 4. Further, careful use of large language models (e.g., GEMINI®, CHATGPT®) may be used to identify the user agent. An example of using a large language model to identify the application advertised by a user agent is depicted in more detail with respect to FIG. 5. In some embodiments, the large language model is used first, and if the large language model fails to provide a result, the user-agent parser may be used. In other embodiments, the user-agent parser may be used first and, if unsuccessful, the large language model may be used. The traffic for the identified application from the user agent is batched into time batches for a given endpoint and application. For initial and updating training of the models, the batches are provided to training engine 135.

Training engine 135 uses the batches of data to extract signals from the traffic to construct comprehensive behavior models (i.e., profiles). Training engine 135 trains the models by providing the signals to the given model for the traffic, and the model is trained to weight the particular signals most relevant to the given application. To detect malware masquerading as a known benign application, a malware model is trained that can receive the traffic and determine whether the behavior of the traffic matches the expected behavior of the application advertised in the user agent. To detect compromised applications, training engine 135 trains a model for each known application. Each of the malware detection model and the application models may include decision tree ensembles such as random forest or gradient boosted trees, linear or logistic models, support vector machines, k-nearest neighbors, probabilistic models, or neural networks. Any such model may be trained per application to represent a behavioral profile corresponding to that application. Multiple models may be maintained concurrently, including models trained to detect malware that falsely advertises an identity as a benign application.

To train the models, more than one-hundred and eighty-five signals from the application traffic is extracted to construct the comprehensive behavior models. These models give us a deeper understanding of the application's behavior from a network perspective. These signals include:
(a) Hostnames that are reached out to by the application.
(b) How much of the application's traffic is referred?
(c) What HTTP methods are typically used? What are the HTTP statuses?
(d) How long do requests and responses take? How much data is sent?
(e) How much of the traffic is going to the known cloud provider domain?
(f) Nature and quantity of the JA3 transport layer security fingerprints.
(g) What are the HTTP request and response content types?
(h) What file types are being uploaded and downloaded?
(i) Sequences or notable patterns that are prominent for the application.

Once trained, the models are stored in model data store 145. Training engine 135 may leverage large data sets of traffic and use a stratified k-fold technique for training. New models may be trained or existing models may be updated using training engine 135, which may be on a separate computing system than used for analysis. However, training engine 135 may provide flexible training services to allow new models to be trained for new applications as customized by a user or customer for network security system 125.

Model data store 145 stores the models including at least one model for identifying malware using misadvertising in the user agent to masquerade as a benign application. Model data store 145 may further include a model for each known application that determines whether traffic adheres to expected behaviors of the application or if it is compromised.

Returning to profiling engine 130, after identifying the advertised application from the user agent and batching the traffic, profiling engine may analyze the subject traffic after the models are trained. Profiling engine 130 may analyze batches of the traffic using the models from model data store 145. The models are used to analyze the behavior to consider the following from the inputted batches:
(a) What does the user agent advertise as the network traffic's source?
(b) How does the traffic compare to a relevant behavioral profile?
(c) Does the behavioral profile match what is advertised for the traffic?

For example, a batch may be analyzed by the misadvertising model to determine whether the traffic indicates that the traffic is consistent with the advertised application. Further, profiling engine 130 may select the relevant application model to analyze the traffic to determine whether the traffic behaves as expected for that particular application. The result of the analysis may be provided to security policy enforcer 140.

Security policy enforcer 140 enforces security policies on all outgoing transactions intercepted by network security system 125 from endpoints 105. Security policy enforcer 140 may identify security policies to apply to outgoing transactions based on, for example, the user account that the outgoing transaction originates from, the endpoint 105 (i.e., user device) that the outgoing transaction originates from, the destination server addressed, the type of communication protocol used, the type of transaction (e.g., document download, document upload, login transaction, or the like), data included in the traffic (e.g., data in the packet), or any combination. Further, security policies may be applied based on results from profiling engine 130. For example, if profiling engine 130 identifies behavior from an endpoint 105 indicating it is infected with malicious software, security policy enforcer 140 may block further traffic to and from that identified endpoint 105, notify an administrator, and the like. The security policies may include malicious software specific policies as well as any other security policies implemented by the organization or entity. Accordingly, security policy enforcer 140 may identify and enforce any other security policies (e.g., security policies other than those related to malicious software described herein). After applying the security policies, the outgoing transaction may be blocked, modified, or transmitted to the destination domain server 120 specified in the outgoing transaction.

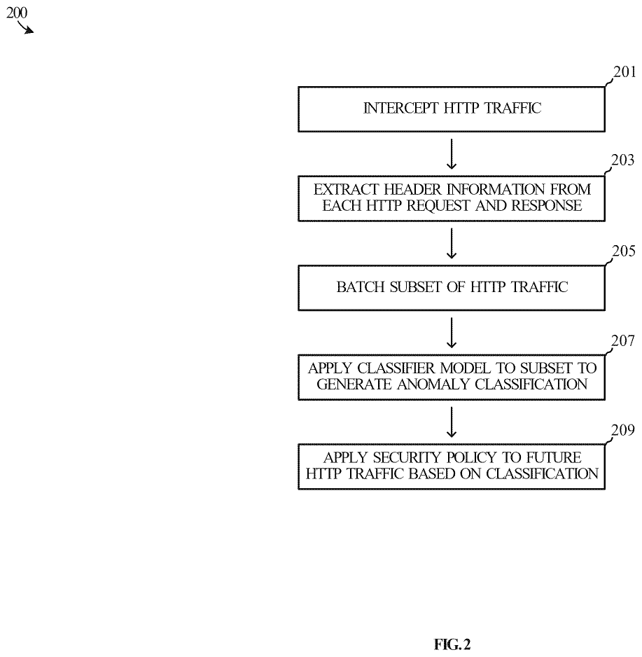

FIG. 2 illustrates detection method 200 of a network security system in accordance with some embodiments. Detection method 200 ). Detection method 200 may include more or fewer steps than those described here, and the described steps may be performed in any order and as many times as needed to detect anomalies in network traffic via a network security system. Detection method 200 may be implemented as hardware, firmware, or software. Detection method 200 may be implemented as executable instructions that, when executed by a processor, direct a computing device to act in accordance with the steps described herein. Where detection method 200 is executable instructions, the instructions may be integrated into or executed by any combination of endpoints 105, destination domain servers 120, network security system 125, or a constituent element thereof.

At step 201, a network security system employing the techniques described herein (e.g., network security system 125 of FIG. 1) intercepts communications of HTTP traffic (i.e., network traffic). The communications include HTTP request and HTTP responses. In some embodiments, the network security system is interposed between endpoint devices (e.g., endpoints 105 of FIG. 1) and destination domain servers (e.g., destination domain servers 120) to monitor or enforce security controls on traffic transmitted between them. In various implementations, the network security system may include network interfaces, deep-packet inspection modules, or routing clients configured to intercept Hypertext Transfer Protocol (HTTP) and HTTP Secure (HTTPS) traffic transmitted over the public network that connects the endpoints and destination domain servers (e.g., public network 115). In some embodiments, the interception may occur through an on-path proxy, a gateway appliance, a cloud-based secure-access node, a virtualized agent deployed within an enterprise network, or a combination thereof. The intercepted communications can include HTTP requests, HTTP responses, complete HTTP request-response pairs, and additional information useful for subsequent analysis (e.g., transport-layer metadata).

At step 203, the network security system extracts header information from each HTTP request and response of the HTTP traffic. The network security system or an element thereof (e.g., profiling engine 130 of FIG. 1) parses packet or session data to obtain header fields such as host, user agent, content-type, content-length, referrer, status, and the like. The network security system may normalize and cache the extracted information for downstream processing. In some embodiments, the network security system filters payload content to retain only metadata required to preserve privacy while maintaining fidelity for behavioral analysis. This extraction provides the header information, including user-agent information, forms the basis for attributing each communication to an originating application.

At step 205, the network security system batches a subset of the HTTP traffic based on an application identified from user-agent information. The subset may be further batched based on an endpoint device from which the communications originated and a time window during which the communications occurred. The user-agent string may be evaluated by one or more attribution components of the network security system. In some implementations, the network security system employs an open-source parser to match known user-agent patterns and identify the application family. In other implementations, the network security system employs a large-language model (LLM) trained to interpret unstructured or falsified user-agent strings, enabling attribution even when the field contains obfuscated or inconsistent text. The resulting batches provide statistical context for the communications, allowing the network security system to evaluate behavioral characteristics such as referrer counts, host diversity, request frequency, and method distribution. In some scenarios, the network security system may further utilize process-level information obtained from the endpoint via the network traffic, such as a process name, process identifier, or executable path, to more accurately correlate observed network traffic with the originating application. Batching may be executed on a rolling basis to create overlapping windows of analysis or may be triggered at fixed intervals depending on network load.

At step 207, the network security system applies an application-specific classifier model to the subset in order to generate an anomaly classification. The network security system (e.g., profiling engine 130 accessing model data store 145 of FIG. 1) may retrieve an application-specific classifier model (i.e., profile) trained on a behavioral profile corresponding to a known application that is identified as corresponding to the subset. The network security system may provide to the classifier model signals extracted from the batch, such as hostnames, HTTP methods and statuses, TLS fingerprints, and content types, and may compare these signals to the pre-identified behavioral profile for the application. In some cases, the network security system determines that the behavior matches the expected profile and therefore no anomaly is detected. In other cases, the network security system determines that the batch exhibits behavior inconsistent with the profile, signifying that the user-agent attribution is inauthentic or that the application itself is compromised. For example, malware may alter the user-agent string to appear as a web browser. The network security system detects the inconsistency between the limited host diversity and lack of referrers typical of the malware and the highly varied traffic pattern expected of a browser application. In another example, a legitimate third-party application, such as a productivity suite component, may begin communicating with new external hosts following a supply-chain compromise. The network security system recognizes that the observed hostnames fall outside the trained behavioral profile and flags the batch as anomalous by generating an anomaly classification indicative of the findings. In some implementations, when an anomaly is detected, the network security system may also output metadata describing a potential source or severity of the anomaly, such as a likelihood score or feature-importance ranking derived from the model's decision path.

At step 209, the network security system, or a constituent element thereof (e.g., security policy enforcer 140 of FIG. 1) applies a security policy to future HTTP traffic based on the anomaly classification returned by the classifier model. In response to the anomaly classification, the network security system may apply one or more security policies to future HTTP traffic associated with the endpoint device, the application, or a combination thereof. Example of such security policies include allowing traffic to continue unimpeded and optionally reinforcing the behavioral profile with additional benign data when no anomaly is detected. When the anomaly classification indicates a spoofed user-agent anomaly, the network security system may block subsequent communications from the process or endpoint, quarantine the affected endpoint device, trigger credential rotation, or notify administrative consoles of possible malware infection. When the anomaly classification indicates a compromised-application anomaly, the network security system may restrict outbound connections to a whitelist of approved hostnames, enforce data-loss-prevention rules, or temporarily suspend access to the external service pending investigation. The network security system may implement policy decisions through existing enterprise frameworks such as proxy access-control lists, software-defined networking controllers, or endpoint orchestration APIs.

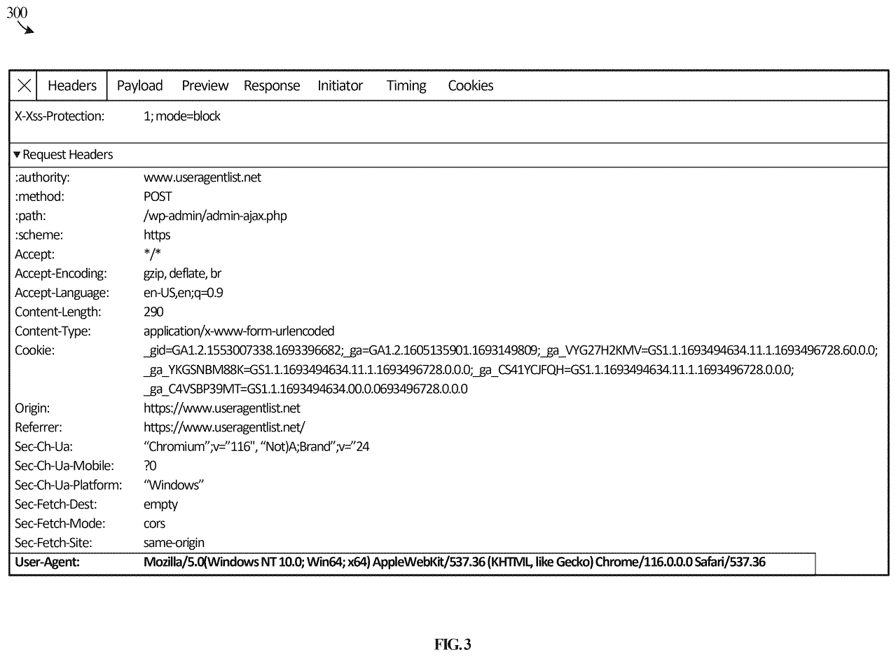

FIG. 3 illustrates example header 300 from an HTTP transaction in accordance with some embodiments. Example header 300 is generally representative of header information that a network security system (e.g., network security system 125) may extract from HTTP traffic. The last line at the bottom of example header 300 represents the user-agent field, which has been bolded for ease of viewing. The user agent is a string that identifies the client software originating the request. It typically contains information describing the application type, operating system, software vendor, and version of the requesting client. Servers may use this information to tailor responses based on the capabilities or limitations of the client device. As discussed above, the user agent may be easily modified, and there is no required standard or structure that the field must follow.

The example user agent in example header 300 is “Mozilla/5.0 (Windows NT 10.0; Win64; x64) AppleWebKit/537.36 (KHTML, like Gecko) Chrome/116.0.0.0 Safari/537.36.” In this string, “Mozilla/5.0” provides compatibility information, “Windows NT 10.0; Win 64; x64” indicates platform details, “AppleWebKit/537.36” identifies the rendering engine used, “KHTML, like Gecko” is a compatibility token, “Chrome/116.0.0.0” designates the browser name and version, and “Safari/537.36” reflects the WEBKIT® version and SAFARI® compatibility. Accordingly, this user-agent string advertises the originating application as the CHROME® internet browser. Because most legitimate network traffic includes user-agent information of this form, such data can be used to assemble large training datasets for the classifier models (i.e., creation of the application-specific behavioral profiles). Although the user-agent field is easily manipulated and is often modified by malicious software attempting to conceal its identity, the majority of network traffic is transmitted without such manipulation. As a result, the abundance of legitimate user-agent information provides a statistically reliable basis for model training. During runtime operation of the network security system, the user-agent information is likewise used when analyzing network traffic. In some embodiments, the system analyzes the network traffic by creating feature vectors that serve as inputs to the classifier models used to classify traffic as malware or compromised applications.

FIG. 4 illustrates example output 400 from a user-agent parser, such as a Python-based parser. Example output 400 is generally representative of an output of a parser that received at a network security system (e.g., network security system 125). Example output 400 may be generated by an element of the network security system (e.g., profiling engine 130 of FIG. 1) or may otherwise be generated by an external service or element. User-agent parser libraries are available that perform string matching between observed user-agent strings and libraries of known user-agent patterns. As shown, the raw user-agent string is “Mozilla/5.0 (Macintosh; Intel Mac OS X 10_15_7) AppleWebKit/537.36 (KHTML, like Gecko) Chrome/134.0.0.0 Safari/537.36.” The parser determines that the application family is CHROME® and outputs version information indicating major version 134, minor version 0, and patch 0. This family and version information may be used by profiling engine 130 to identify the application advertised by the user-agent information.

FIG. 5 illustrates an example prompt and response 500 in accordance with some embodiments. Example prompt and response 500 includes prompt 501 and response 503. Prompt 501 represents an example query submitted to a generative artificial intelligence (GAI) model, such as a large-language model (LLM) like GEMINI®, CHATGPT®, or a comparable model, to identify the application advertised within a user-agent string. In this example, the prompt instructs the GAI model to return the identified application and operating system in JSON format via response 503. In certain embodiments, profiling engine 130 may submit a collection of user-agent strings extracted from network traffic to the GAI model for attribution. The GAI model analyzes each user-agent string and returns response 503, which includes structured information identifying the corresponding application, operating system, and other descriptive attributes. Response 503 may then be provided to profiling engine 130, which uses the returned attribution information to batch the underlying HTTP traffic by application, originating endpoint, time window, or combinations thereof. Such batching may be performed regardless of whether a parser, a large-language model, or another GAI model is used to analyze the user-agent information. As described above, once the traffic is batched, profiling engine 130 may employ the resulting data for analysis of live network traffic using the trained models or for configuring the classifier models.

As used herein, generative artificial intelligence (GAI) models (also sometimes known as foundation models) refers to models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

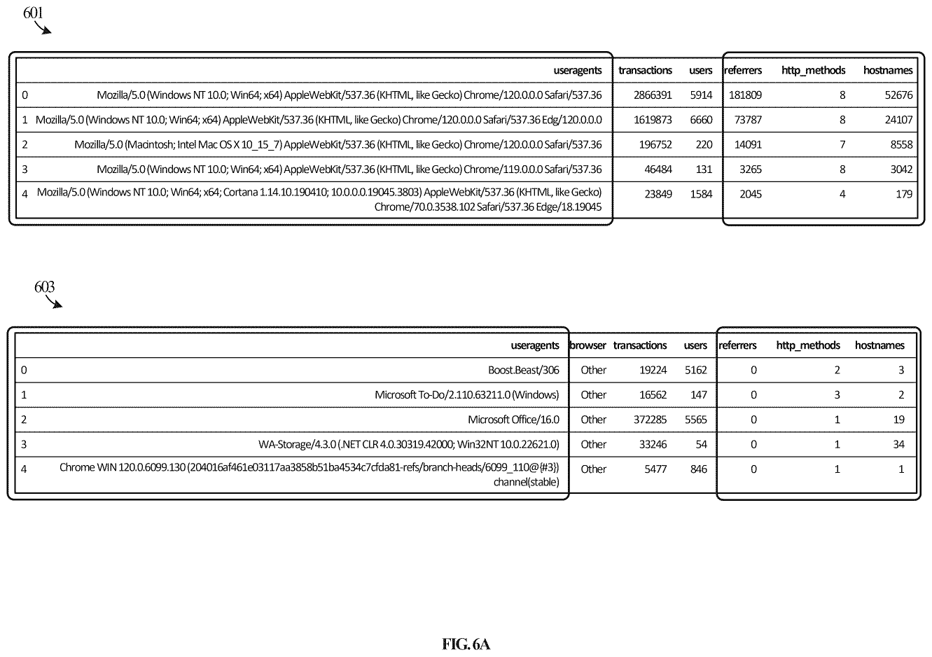

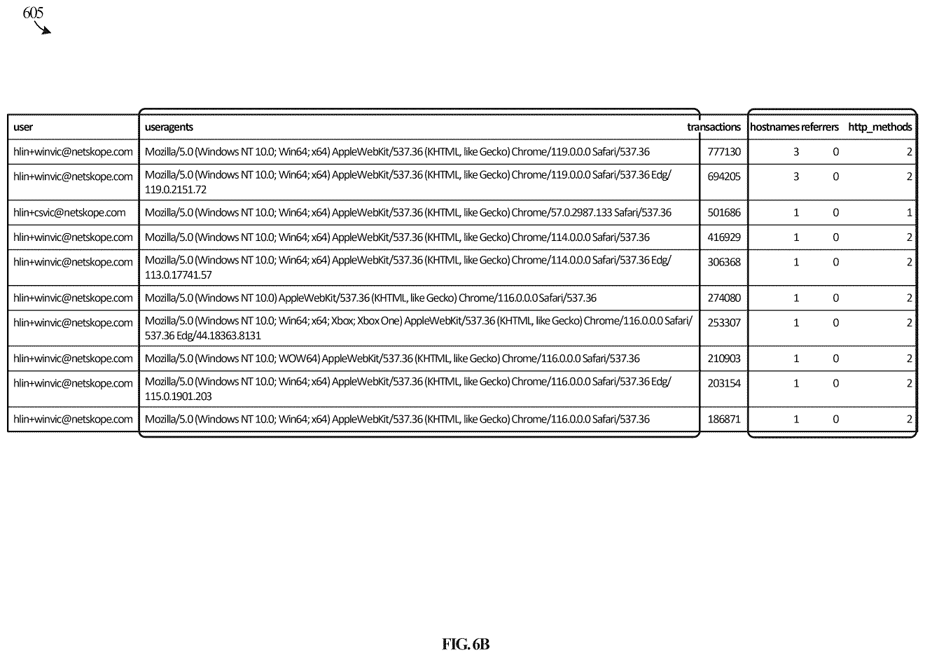

FIGS. 6A and 6B illustrate example sets of traffic and their corresponding results, depicting a subset of data that demonstrates the behavior of traffic including traffic that is not anomalous and also malware, i.e., misadvertising applications that masquerade as known benign traffic.

In FIG. 6A, traffic 601 is representative of network traffic in which the user-agent information corresponds to expected behavior in a behavioral profile for the associated application and therefore may be used for training or analysis. For each line item of traffic 601, the user agent is shown along with the number of transactions analyzed, the number of users contributing to those transactions, the number of referrers, the number of HTTP methods, and the hostnames to which the application connected. Each line item of traffic 601 represents a distinct browser version (e.g., Chrome/120.0.0.0, Chrome/70.0.3538.102, etc.). As expected, browser traffic includes numerous referrers (since one webpage refers to others and renders data from multiple sources on the Internet), many hostnames (because browsers connect to a wide range of destination domain servers 120), and a moderate number of HTTP methods, typically fewer than ten.

Traffic 603 is representative of network traffic in which the user-agent information corresponds to applications other than browsers and may likewise be used for training or analysis. For each line item, the same attributes described above are depicted, but the user agents identify different application families such as BOOST BEAST, Microsoft To Do, and MICROSOFT OFFICE. For these applications, there are no referrers because the applications do not render content from other locations, the number of HTTP methods is small (not exceeding three), and the number of hostnames is limited, often only two or three. Where the browser traffic in FIG. 6A exhibits thousands of accessed hostnames, these applications in FIG. 6B connect to a narrow, predictable set of servers, typically their respective home or cloud service endpoints. The behavior discernable from both traffic 601 and traffic 603 represents well-defined patterns that can later be used to detect anomalies or compromises in future traffic for the same application. In some embodiments, the network security system includes such behavioral information for any number of applications or browsers.

In FIG. 6B, traffic 605 is representative of network traffic in which the user-agent information advertises a browser application (e.g., CHROME®) but exhibits network behavior inconsistent with that of an actual browser. As shown, the number of hostnames is very small, which is atypical of browser behavior. There are also no referrers, which likewise deviates from expected browser activity. The number of HTTP methods per user agent is also limited to one or two. When compared to traffic 601 of FIG. 6A, this traffic, while advertised as browser traffic, behaves like an application rather than a browser. These examples represent malware applications that falsely advertise themselves as browser software. The classifier model trained to detect misadvertising malware can identify such traffic with the accuracy levels as described herein.

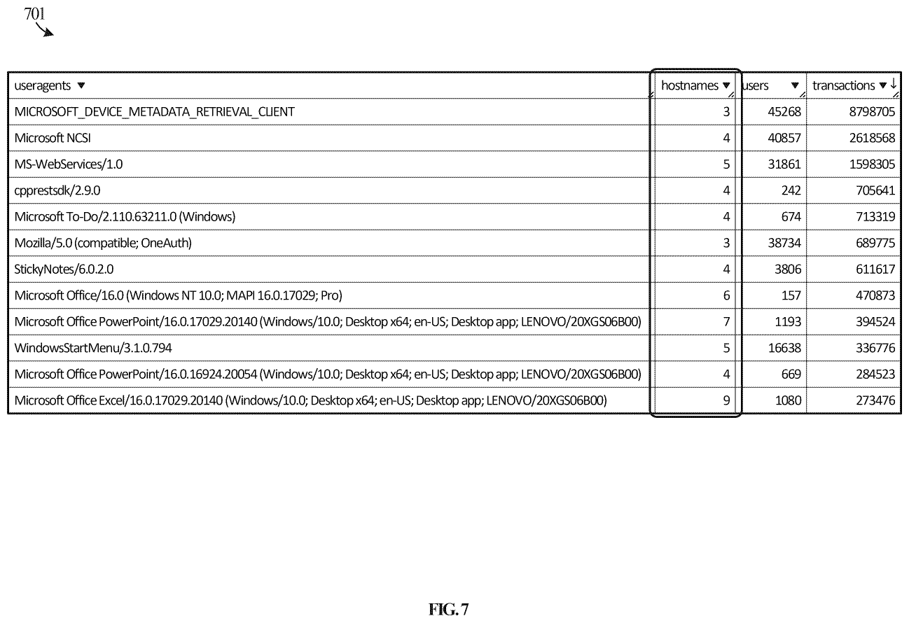

FIG. 7 illustrates data 701 from network traffic that may be used to identify compromised applications using the models stored in model data store 145. The user-agent information shown in this data 701 identifies the originating application for each communication. Examples depicted include Microsoft Device Metadata Retrieval Client (first line), MICROSOFT TO DO (fifth line), STICKY NOTES (seventh line), MICROSOFT OFFICE POWERPOINT (ninth line), and MICROSOFT OFFICE EXCEL (last line), among others. Similar to traffic 603 of FIG. 6B, this data illustrates the well-defined behavioral patterns of legitimate applications that can be used to train classifier models for those specific applications. Future traffic that deviates from the established behavioral patterns may indicate compromise of the corresponding application, which will be detected by the respective model.

For example, the model for MICROSOFT OFFICE EXCEL may be trained on traffic specific to that application, which in this instance indicates communication with nine hostnames. Future traffic attributed to MICROSOFT OFFICE EXCEL is analyzed for behavior consistent with that profile. If the future traffic exhibits behavior that differs from the trained pattern (e.g., communicating with a greater or lesser number of hostnames or with hostnames outside the known set), the model may determine that the application is compromised. Although this example highlights one indicator, namely the number of hostnames accessed, the classifier models use many such indicators to evaluate network behavior. In some embodiments, more than one-hundred and eighty-five distinct signals may be analyzed both to configure behavioral profiles for a given application and as the input to a classifier model trained to determine whether the application exhibits anomalous or potentially compromised behavior.

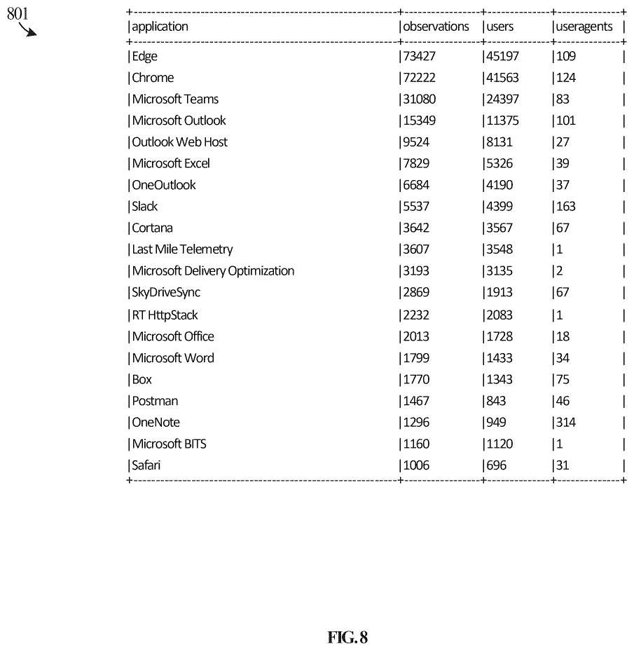

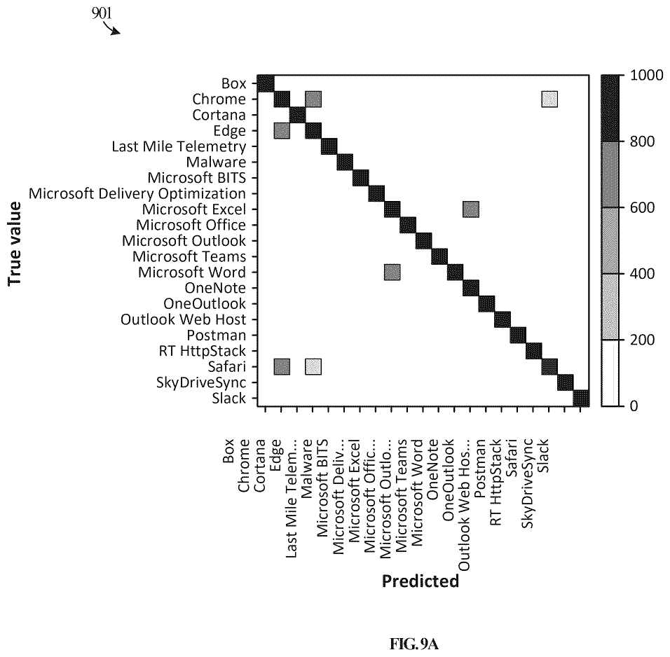

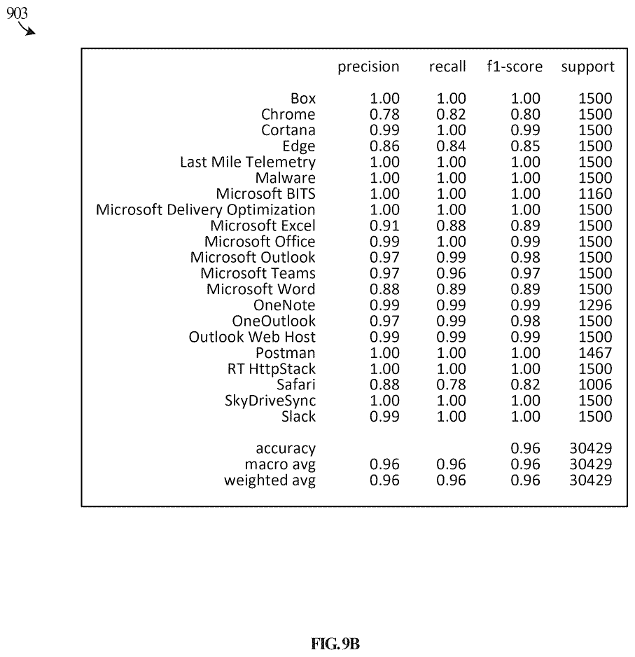

FIG. 8 illustrates information 801 representing traffic used to train the application-specific models that are configured to detect application compromise. For each named application, the number of observations indicates the number of batches of transactions obtained and used to train the corresponding model. The training traffic includes observations, i.e., batches of transactions, collected from many users and containing numerous distinct user-agent strings. Because user-agent strings are free-form text fields that may include additional information beyond the application identity, multiple unique user-agent strings can correspond to the same application, as depicted in FIG. 9A. For example, the user-agent string for a given application, such as MICROSOFT EDGE® or GOOGLE CHROME®, may vary depending on the operating system on which the application is executed. As shown, the training data encompasses many thousands of transactions, providing statistically significant input for developing the behavioral profiles of the respective applications.

FIG. 9A illustrates a heat map 901 representing the performance of the classifier model used to detect malware that misadvertises itself as benign application traffic. In this embodiment, the heat map functions as a confusion matrix in which the vertical axis represents the true class label for each application and the horizontal axis represents the class predicted by the trained model. Each cell in the matrix corresponds to the number of traffic samples classified in that category, with darker shading indicating a higher count. A strong diagonal band extending from the upper left to the lower right demonstrates that the model correctly classified the vast majority of traffic samples for their respective applications.

Limited off-diagonal activity is observed where the model exhibits minor confusion among applications with highly similar network behavior. For example, small misclassifications occur between certain browsers such as MICROSOFT EDGE®, GOOGLE CHROME®, and SAFARI®, and between productivity applications such as MICROSOFT WORD and MICROSOFT EXCEL. These minor deviations have little negative consequence because the affected applications are functionally and behaviorally similar and all represent benign traffic. The matrix also shows slight overlap between SAFARI® and RT HTTPSTACK, likely reflecting shared transport layer characteristics.

Importantly, the malware class, which appears as the fifth entry from the top left of the matrix, is correctly identified with high accuracy. The near absence of off-diagonal entries involving the malware class indicates that the classifier model effectively distinguishes malicious traffic that advertises itself as a benign browser from legitimate browser traffic. Overall, the results illustrated in FIG. 9A demonstrate a high correlation between predicted and true classifications and validate the model's ability to detect misadvertised malware applications with strong precision across diverse application types.

FIG. 9B illustrates tabular data 903 representing the quantitative performance metrics of the classifier model whose results are depicted in FIG. 9A. The table lists precision, recall, F1 score, and support for each application class used to train and evaluate the model. Precision represents the proportion of samples that were correctly identified out of all samples predicted to belong to a given class. Recall represents the proportion of correctly identified samples out of all samples that actually belong to that class. The F1 score is the harmonic mean of precision and recall and provides a single value that balances both measures of accuracy. Support indicates the number of samples used for each class in the evaluation dataset.

Tabular data 903 shows that the classifier model achieved an overall accuracy of approximately ninety-six percent across more than thirty thousand samples, with both the macro average and weighted average of precision, recall, and F1 score also reaching approximately ninety-six percent. High precision and recall values are observed for nearly all application classes, including the malware class, which achieved perfect detection. Minor variation appears among certain browser classes such as CHROME®, EDGE®, and SAFARI®, reflecting their overlapping network characteristics. The quantitative results in FIG. 9B confirm the performance illustrated in FIG. 9A and demonstrate that the classifier model reliably distinguishes malware and compromised applications from legitimate application traffic with high accuracy and consistency across diverse application types.

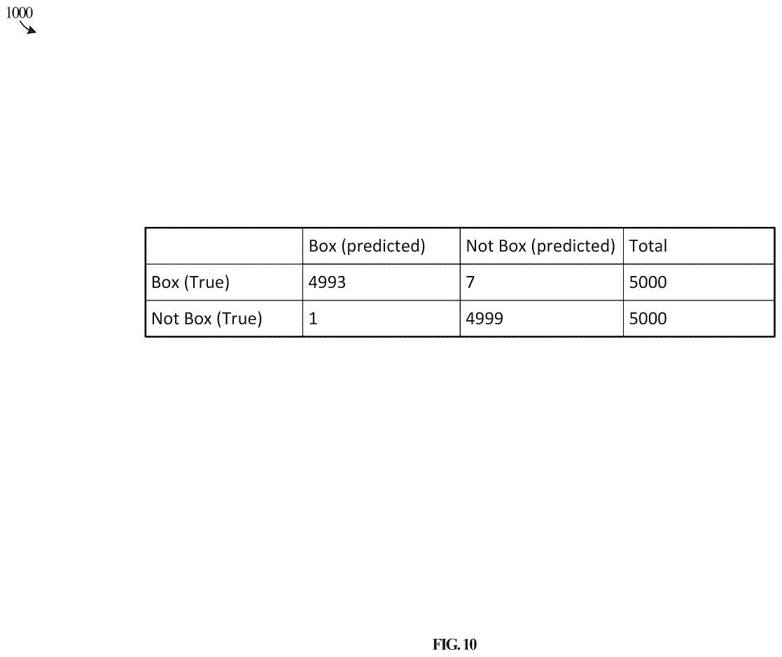

FIG. 10 illustrates example evaluation data for a classifier model trained to detect whether network traffic corresponds to the BOX® application or to non-BOX® traffic indicative of a compromise. BOX® is a widely used enterprise cloud storage and content collaboration service that allows users to upload, access, and share files over the Internet. The figure presents a binary confusion matrix containing 10,000 total samples, evenly divided between true BOX® traffic and true non-BOX® traffic. Of the 5,000 BOX® samples, the model correctly classified 4,993 as BOX® and misclassified 7 as non-BOX®. Of the 5,000 non-BOX® samples, the model correctly classified 4,999 and misclassified a single sample as BOX®. These results demonstrate extremely high accuracy for the application-specific model, confirming its ability to distinguish legitimate BOX® traffic from anomalous or potentially compromised traffic. The same approach applied across other applications yields similarly high performance for detecting compromised applications and for identifying malware that falsely advertises itself as a benign application.

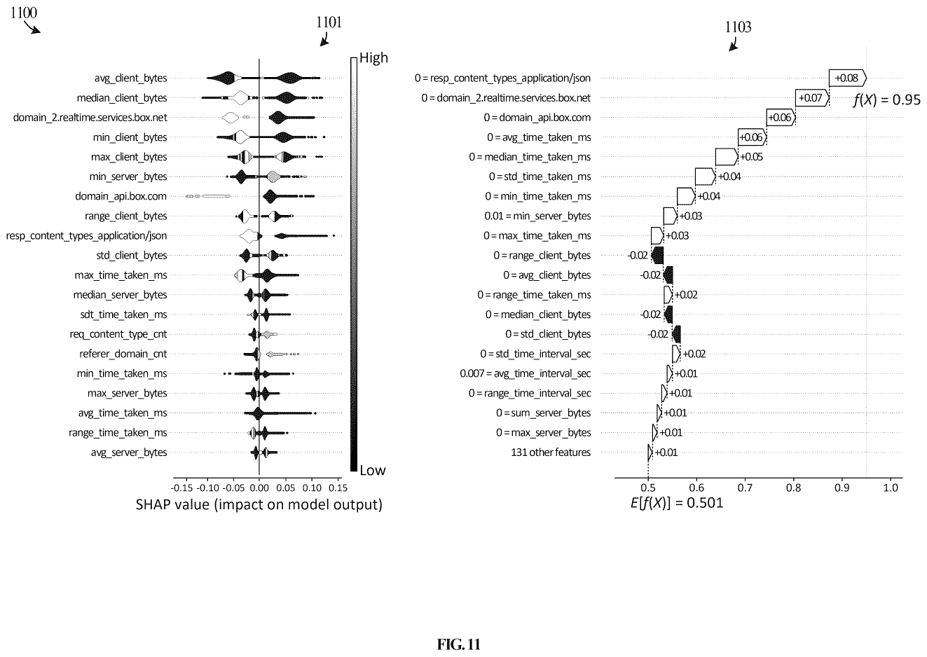

FIG. 11 illustrates example feature-importance data 1100 for a classifier model evaluating traffic for a particular application. Example feature-importance data 1100 includes graph 1101, which is a feature impact summary graph, and graph 1103, which is a feature importance ranking graph. Each of graph 1101 and graph 1103 presents SHAP (Shapley Additive Explanations) values that quantify the influence of individual traffic features on the model output. In graph 1101, each row corresponds to a traffic feature extracted by the profiling engine, such as average client bytes, median client bytes, domain indicators, or response content types. The horizontal spread of the data points represents the extent to which that feature increases or decreases the likelihood that the traffic matches the behavioral profile for the application. Features located toward the top of graph 1101 exhibit greater overall influence on the model's decision.

Graph 1103 presents the mean absolute SHAP values for the same features, ranking them by average contribution to the model classification. In this example, features including response content type, domain association, and timing metrics such as average and median client bytes exert the greatest effect on the model determination. When the SHAP values for the traffic align closely with those expected for the application, the model identifies the traffic as consistent with the legitimate application. Conversely, significant deviations in key feature values indicate that the traffic behavior does not correspond to the expected application profile, suggesting a potential compromise. This interpretability technique allows the profiling engine to explain which specific behavioral features led to a determination of normal or anomalous application behavior.

FIG. 12 illustrates a computing device 1200. The computing device 1200 includes various components not included for ease of description in other computing devices discussed herein including, for example, endpoints 105, network security system 125, and destination domain servers 120. Accordingly, computing device 1200 may be endpoints 105, network security system 125, or destination domain servers 120 by incorporating the functionality described in each.

Computing device 1200 is suitable for implementing processing operations described herein related to security enforcement and malware detection, with which aspects of the present disclosure may be practiced. Computing device 1200 may be configured to implement processing operations of any component described herein including the user system components (e.g., endpoints 105 of FIG. 1). As such, computing device 1200 may be configured as a specific purpose computing device that executes specific processing operations to solve the technical problems described herein including those pertaining to security enforcement and document malware detection. Computing device 1200 may be implemented as a single apparatus, system, or device or may be implemented in a distributed manner as multiple apparatuses, systems, or devices. For example, computing device 1200 may comprise one or more computing devices that execute processing for applications and/or services over a distributed network to enable execution of processing operations described herein over one or more applications or services. Computing device 1200 may comprise a collection of devices executing processing for front-end applications/services, back-end applications/services, or a combination thereof. Computing device 1200 includes, but is not limited to, a bus 1205 communicably coupling processors 1210, output devices 1215, communication interfaces 1220, input devices 1225, power supply 1230, and memory 1235.

Non-limiting examples of computing device 1200 include smart phones, laptops, tablets, PDAs, desktop computers, servers, blade servers, cloud servers, smart computing devices including television devices and wearable computing devices including VR devices and AR devices, e-reader devices, gaming consoles, and conferencing systems, among other non-limiting examples.

Processors 1210 may include general processors, specialized processors such as graphical processing units (GPUs), neural processing units (NPUs), and digital signal processors (DSPs), or a combination. Processors 1210 may load and execute software 1240 from memory 1235. Software 1240 may include one or more software components such as profiling engine 130, training engine 135, security policy enforcer 140, or any combination including other software components. In some examples, computing device 1200 may be connected to other computing devices (e.g., display device, audio devices, servers, mobile devices, remote devices, VR devices, AR devices, or the like) to further enable processing operations to be executed. When executed by processors 1210, software 1240 directs processors 1210 to operate as described herein for at least the various processes, operational scenarios, and sequences discussed in the foregoing implementations. Computing device 1200 may optionally include additional devices, features, or functionality not discussed for purposes of brevity. For example, software 1240 may include an operating system that is executed on computing device 1200. Computing device 1200 may further be utilized as endpoints 105 or any of the cloud computing systems in security environment 100 (FIG. 1) including network security system.

Referring still to FIG. 12, processors 1210 may include a processor or microprocessor and other circuitry that retrieves and executes software 1240 from memory 1235. Processors 1210 may be implemented within a single processing device but may also be distributed across multiple processing devices or sub-systems that cooperate in executing program instructions. Examples of processors 1210 include general purpose central processing units, microprocessors, graphical processing units, application specific processors, sound cards, speakers and logic devices, gaming devices, VR devices, AR devices as well as any other type of processing devices, combinations, or variations thereof.

Memory 1235 may include any computer-readable storage device readable by processors 1210 and capable of storing software 1240 and data stores 1245. Data stores 1245 may include data stores that maintain security policies used by security policy enforcer 140 or that stores the profiling models described herein such as model data store 145, for example.

Memory 1235 may include volatile and nonvolatile, removable, and non-removable media implemented in any method or technology for storage of information, such as computer readable instructions, data structures, program modules, cache memory, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer-readable storage device a propagated signal.

In addition to computer-readable storage devices, in some implementations, memory 1235 may also include computer-readable communication media over which at least some of software 1240 may be communicated internally or externally. Memory 1235 may be implemented as a single storage device but may also be implemented across multiple storage devices or sub-systems co-located or distributed relative to each other. Memory 1235 may include additional elements, such as a controller, capable of communicating with processors 1210 or possibly other systems.

Software 1240 may be implemented in program instructions and among other functions may, when executed by processors 1210, direct processors 1210 to operate as described with respect to the various operational scenarios, sequences, and processes illustrated herein. For example, software 1240 may include program instructions for training models (e.g., training engine 135), analyzing transactions and using the models (e.g., profiling engine 130), or performing security enforcement (e.g., security policy enforcer 140), as described herein.

In particular, the program instructions may include various components or modules that cooperate or otherwise interact to conduct the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1240 may include additional processes, programs, or components, such as operating system software, virtual machine software, or other application software. Software 1240 may also include firmware or some other form of machine-readable processing instructions executable by processors 1210.

In general, software 1240 may, when loaded into processors 1210 and executed, transform a suitable apparatus, system, or device (of which computing device 1200 is representative) overall from a general-purpose computing system into a special-purpose computing system customized to execute specific processing components described herein as well as process data and respond to queries. Indeed, encoding software 1240 on memory 1235 may transform the physical structure of memory 1235. The specific transformation of the physical structure may depend on various factors in different implementations of this description. Examples of such factors may include, but are not limited to, the technology used to implement the storage media of memory 1235 and whether the computer-storage media are characterized as primary or secondary storage, as well as other factors.

For example, if the computer readable storage device is implemented as semiconductor-based memory, software 1240 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interfaces 1220 may include communication connections and devices that allow for communication with other computing systems (not shown) over communication networks (not shown). Communication interfaces 1220 may also be utilized to cover interfacing between processing components described herein. Examples of connections and devices that together allow for inter-system communication may include network interface cards or devices, antennas, satellites, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication interfaces 1220 may also include associated user interface software executable by processors 1210 in support of the various user input and output devices discussed below. Separately or in conjunction with each other and other hardware and software elements, the user interface software and user interface devices may support a graphical user interface, a natural user interface, or any other type of user interface, for example, which enables front-end processing and including rendering of user interfaces, such as a user interface that is used by a user on endpoint 105. Exemplary applications and services may further be configured to interface with processing components of computing device 1200 that enable output of other types of signals (e.g., audio output, handwritten input) in conjunction with operation of exemplary applications or services (e.g., a collaborative communication application or service, electronic meeting application or service, or the like) described herein.

Input devices 1225 may include a keyboard, a mouse, a voice input device, a touch input device for receiving a touch gesture from a user, a motion input device for detecting non-touch gestures and other motions by a user, gaming accessories (e.g., controllers and/or headsets) and other comparable input devices and associated processing elements capable of receiving user input from a user. Output devices 1215 may include a display, speakers, haptic devices, and the like. In some cases, the input and output devices may be combined in a single device, such as a display capable of displaying images and receiving touch gestures. The aforementioned user input and output devices are well known in the art and need not be discussed at length here.

Communication between computing device 1200 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

The computing device 1200 has a power supply 1230, which may be implemented as one or more batteries. The power supply 1230 may further include an external power source, such as an AC adapter or a powered docking cradle that supplements or recharges the batteries. In some embodiments, the power supply 1230 may not include batteries and the power source may be an external power source such as an AC adapter.

The aforementioned discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

### EXAMPLES

The following illustrative examples are mentioned not to limit or define the scope of this disclosure, but rather to provide examples to aid understanding thereof. Illustrative examples are discussed above in the Detailed Description, which provides further description.

Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).
Example 1 is a method, comprising: intercepting, by a network security system interposed between endpoint devices and destination domain servers, hypertext transfer protocol (HTTP) traffic between the endpoint devices and the destination domain servers; extracting header information including user-agent information from each HTTP request and each HTTP response of the HTTP traffic; batching, by a profiling engine of the network security system, a subset of the HTTP traffic, wherein the subset is selected based at least in part on an endpoint device of the endpoint devices identified based on the header information and an application identified based on the user-agent information; applying, by the profiling engine, an application-specific classifier model to the subset, wherein the application-specific classifier model is trained to generate an anomaly classification based on comparing the header information of the subset in combination with the user-agent information of the subset to a behavioral profile corresponding to the application; and applying, by a security policy enforcer of the network security system, a security policy to future HTTP traffic associated with the endpoint device and the application based at least in part on the anomaly classification.
Example 2 is the method of any previous or subsequent example, wherein applying the application-specific classifier model to the subset comprises: extracting, by the profiling engine, a plurality of signals from the subset; creating, by the profiling engine, a feature vector from the plurality of signals; and submitting, by the profiling engine, the feature vector to the application-specific classifier model.
Example 3 is the method of any previous or subsequent example, wherein the plurality of signals comprises hostnames accessed, referrer counts, HTTP methods, HTTP status codes, request and response latencies, data transfer sizes, Transport Layer Security (TLS) fingerprints, content types, file types, or a combination thereof.
Example 4 is the method of any previous or subsequent example, wherein the application-specific classifier model comprises an application model trained to detect a compromised application exhibiting deviations from expected network behavior relative to the behavioral profile, and the anomaly classification comprises an indication that the application associated with the subset comprises the compromised application.
Example 5 is the method of any previous or subsequent example, wherein the application-specific classifier model comprises a misadvertising model trained to detect communications presented by malware that identify as originating from the application, and the anomaly classification comprises an indication that the subset of HTTP traffic comprises the communications presented by malware that identify as originating from the application.
Example 6 is the method of any previous or subsequent example, wherein the subset of the HTTP traffic is selected further based on a time window associated with the subset.
Example 7 is the method of any previous or subsequent example, wherein the behavioral profile comprises pre-identified patterns of behavior associated with HTTP traffic attributed to the application.
Example 8 is the method of any previous or subsequent example, wherein applying the security policy comprises one or more of: blocking transmission of future HTTP traffic associated with the endpoint device, blocking transmission of future HTTP traffic associated with the application, modifying a user score for a user associated with the endpoint device, modifying a device score for the endpoint device, modifying an application score for the application, and adding the application to a blacklist of the network security system.
Example 9 is the method of any previous or subsequent example, further comprising: batching, by a training engine of the network security system, training subsets of the HTTP traffic, wherein the training subsets are selected based at least in part on the application identified based on the user-agent information of the training subsets; and training, by the training engine, the application-specific classifier model using the header information of the training subsets in combination with the user-agent information of the training subsets to establish the behavioral profile corresponding to the application.
Example 10 is the method of any previous or subsequent example, wherein batching the subset of the HTTP traffic comprises: generating, by the profiling engine, a prompt for submission to a generative artificial intelligence (GAI) model, wherein: the prompt comprises the user-agent information, and the prompt directs the GAI model to return an application attribution that identifies the application based on the user-agent information; and receiving, at the profiling engine, the application attribution from the GAI model, wherein the application is identified using the application attribution.
Example 11 is a network security system interposed between endpoint devices and destination domain servers, the network security system comprising: a profiling engine configured to: intercept hypertext transfer protocol (HTTP) traffic between the endpoint devices and the destination domain servers; extract header information including user-agent information from each HTTP request and each HTTP response of the HTTP traffic; batch a subset of the HTTP traffic, wherein the subset is selected based at least in part on an endpoint device of the endpoint devices identified based on the header information and an application executing on the endpoint device identified based on the user-agent information; apply an application-specific classifier model to the subset, wherein the application-specific classifier model is trained to generate an anomaly classification based on comparing the header information of the subset in combination with the user-agent information of the subset to a behavioral profile corresponding to the application; and a security policy enforcer configured to apply a security policy to future HTTP traffic associated with the endpoint device and the application based at least in part on the anomaly classification.
Example 12 is the network security system of any previous or subsequent example, wherein to apply the application-specific classifier model to the subset, the profiling engine is further configured to: extract a plurality of signals from the subset; create a feature vector from the plurality of signals; and submit the feature vector to the application-specific classifier model.
Example 13 is the network security system of any previous or subsequent example, wherein the plurality of signals comprise hostnames accessed, referrer counts, HTTP methods, HTTP status codes, request and response latencies, data transfer sizes, Transport Layer Security (TLS) fingerprints, content types, file types, or a combination thereof.
Example 14 is the network security system of any previous or subsequent example, wherein: the application-specific classifier model comprises an application model trained to detect a compromised application exhibiting deviations from expected network behavior relative to the behavioral profile, and the anomaly classification comprises an indication that the application associated with the subset comprises the compromised application.
Example 15 is the network security system of any previous or subsequent example, wherein: the application-specific classifier model comprises a misadvertising model trained to detect communications presented by malware that identify as originating from the application, and the anomaly classification comprises an indication that the subset of HTTP traffic comprises the communications presented by malware that identify as originating from the application.
Example 16 is the network security system of any previous or subsequent example, wherein to batch the subset of the HTTP traffic based on the user-agent information, the profiling engine is further configured to batch the subset of the HTTP traffic based at least in part on a time window associated with the subset.
Example 17 is the network security system of any previous or subsequent example, wherein the behavioral profile comprises pre-identified patterns of behavior associated with HTTP traffic attributed to the application.
Example 18 is the network security system of any previous or subsequent example, wherein to apply the security policy, the security policy enforcer is configured to: block transmission of at least a portion of the HTTP traffic, block transmission of a portion of the HTTP traffic associated with the endpoint device, block transmission of a portion of the HTTP traffic associated with the application, modify a device score for the endpoint device, modify an application score for the application, blacklist the endpoint device, blacklist the application, or a combination thereof.
Example 19 is the network security system of any previous or subsequent example, further comprising a training engine configured to: batch training subsets of the HTTP traffic, wherein the training subsets are selected based at least in part on the application identified based on the user-agent information of the training subsets; and train the application-specific classifier model using the header information of the training subsets in combination with the user-agent information of the training subsets to establish the behavioral profile corresponding to the application.
Example 20 is one or more computer-readable storage media having program instructions stored thereon that, when read and executed by one or more processors of a computing device, direct the computing device to at least: intercept hypertext transfer protocol (HTTP) traffic between endpoint devices and destination domain servers, wherein the computing device is interposed between the endpoint devices and the destination domain servers; extract header information including user-agent information from each HTTP request and each HTTP response of the HTTP traffic; batch a subset of the HTTP traffic, wherein the subset is selected based at least in part on an endpoint device of the endpoint devices identified based on the header information and an application executing on the endpoint device identified based on the user-agent information; apply an application-specific classifier model to the subset, wherein the application-specific classifier model is trained to generate an anomaly classification based on comparing the header information of the subset in combination with the user-agent information of the subset to a behavioral profile corresponding to the application; and apply a security policy to future HTTP traffic associated with the endpoint device and the application based at least in part on the anomaly classification.

1. A method, comprising:
intercepting, by a network security system interposed between endpoint devices and destination domain servers, hypertext transfer protocol (HTTP) traffic between the endpoint devices and the destination domain servers;
extracting header information including user-agent information from each HTTP request and each HTTP response of the HTTP traffic;
batching, by a profiling engine of the network security system, a subset of the HTTP traffic, wherein the subset is selected based at least in part on an endpoint device of the endpoint devices identified based on the header information and a potential application identified based on the user-agent information, wherein the potential application corresponds to a known application;
selecting, from a plurality of application-specific classifier models, an application-specific classifier model associated with the known application, wherein the application-specific classifier model is trained to identify network traffic behavior of the potential application that is inconsistent with network traffic behavior of the known application based on a network traffic behavioral profile corresponding to the known application;
determining the network traffic behavior of the potential application is inconsistent with the network traffic behavior of the known application based on applying, by the profiling engine, the application-specific classifier model to the subset, the determining comprising:
generating, by the application-specific classifier model, an anomaly classification based on comparing the header information of the subset in combination Page 2 of 17 with the user-agent information of the subset to the network traffic behavioral profile; and
applying, by a security policy enforcer of the network security system, a security policy to future HTTP traffic associated with the endpoint device and the potential application based at least in part on the anomaly classification, wherein:
the applying the security policy comprises performing a security action on the future HTTP traffic to limit future damage caused by the future HTTP traffic, and
the security action comprises blocking at least a portion of the future HTTP traffic.

2. The method of claim 1, wherein applying the application-specific classifier model to the subset comprises:
extracting, by the profiling engine, a plurality of signals from the subset;
creating, by the profiling engine, a feature vector from the plurality of signals; and
submitting, by the profiling engine, the feature vector to the application-specific classifier model.

3. The method of claim 2, wherein the plurality of signals comprises hostnames accessed, referrer counts, HTTP methods, HTTP status codes, request and response latencies, data transfer sizes, Transport Layer Security (TLS) fingerprints, content types, file types, or a combination thereof.

4. The method of claim 1, wherein:
the application-specific classifier model comprises an application model trained to detect a compromised application exhibiting deviations from expected network traffic behavior relative to the network traffic behavioral profile, and
the anomaly classification comprises an indication that the potential application associated with the subset comprises the compromised application.

5. The method of claim 1, wherein:
the application-specific classifier model comprises a misadvertising model trained to detect communications presented by malware that identify as originating from the known application, and
the anomaly classification comprises an indication that the subset of HTTP traffic comprises the communications presented by malware that identify as originating from the known application.

6. The method of claim 1, wherein the subset of the HTTP traffic is selected further based on a time window associated with the subset.

7. The method of claim 1, wherein the network traffic behavioral profile comprises pre-identified patterns of network traffic behavior associated with HTTP traffic attributed to the known application.

8. The method of claim 1, wherein applying the security policy comprises one or more of:
blocking transmission of a portion of the future HTTP traffic associated with the endpoint device,
blocking transmission of a portion of the future HTTP traffic associated with the potential application,
modifying a user score for a user associated with the endpoint device,
modifying a device score for the endpoint device,
modifying an application score for the potential application, and
adding the potential application to a blacklist of the network security system.

9. The method of claim 1, further comprising:
batching, by a training engine of the network security system, training subsets of the HTTP traffic, wherein the training subsets are selected based at least in part on the known application identified based on the user-agent information of the training subsets; and
training, by the training engine, the application-specific classifier model using the header information of the training subsets in combination with the user-agent information of the training subsets to establish the network traffic behavioral profile corresponding to the known application.

10. The method of claim 1, wherein batching the subset of the HTTP traffic comprises:
generating, by the profiling engine, a prompt for submission to a generative artificial intelligence (GAI) model, wherein:
the prompt comprises the user-agent information, and
the prompt directs the GAI model to return an application attribution that identifies the potential application based on the user-agent information; and
receiving, at the profiling engine, the application attribution from the GAI model, wherein the potential application is identified using the application attribution.

11. A network security system interposed between endpoint devices and destination domain servers, the network security system comprising:
one or more computer-readable storage media;
one or more processors operatively coupled with the one or more computer-readable storage media; and
program instructions stored on the one or more computer-readable storage media that, when read and executed by the one or more processors, direct a computing device to at least:
implement a profiling engine of the network security system, wherein the profiling engine is configured to:
intercept hypertext transfer protocol (HTTP) traffic between the endpoint devices and the destination domain servers;
extract header information including user-agent information from each HTTP request and each HTTP response of the HTTP traffic;
batch a subset of the HTTP traffic, wherein the subset is selected based at least in part on an endpoint device of the endpoint devices identified based on the header information and a potential application executing on the endpoint device identified based on the user-agent information, wherein the potential application corresponds to a known application;
select, from a plurality of application-specific classifier models, an application-specific classifier model associated with the known application, wherein the application-specific classifier model is trained to identify network traffic behavior of the potential application that is inconsistent with network traffic behavior of the known application based on a network traffic behavioral profile corresponding to the known application;
determine the network traffic behavior of the potential application is inconsistent with the network traffic behavior of the known application based on an application of the application-specific classifier model to the subset, wherein to determine the network traffic behavior of the potential application is inconsistent with the network traffic behavior of the known application, the profiling engine is configured to:
generate, by the application-specific classifier model, an anomaly classification based on comparing the header information of the subset in combination with the user-agent information of the subset to the network traffic behavioral profile, and
implement a security policy enforcer of the network security system, wherein the security policy enforcer is configured to apply a security policy to future Page 6 of 17 HTTP traffic associated with the endpoint device and the potential application based at least in part on the anomaly classification, wherein:
to apply the security policy, the security policy enforcer is configured to perform a security action on the future HTTP traffic to limit future damage caused by the future HTTP traffic; and
the security action comprises blocking at least a portion of the future HTTP traffic.

12. The network security system of claim 11, wherein to apply the application-specific classifier model to the subset, the profiling engine is further configured to:
extract a plurality of signals from the subset;
create a feature vector from the plurality of signals; and
submit the feature vector to the application-specific classifier model.

13. The network security system of claim 12, wherein the plurality of signals comprise hostnames accessed, referrer counts, HTTP methods, HTTP status codes, request and response latencies, data transfer sizes, Transport Layer Security (TLS) fingerprints, content types, file types, or a combination thereof.

14. The network security system of claim 11, wherein:
the application-specific classifier model comprises an application model trained to detect a compromised application exhibiting deviations from expected network traffic behavior relative to the network traffic behavioral profile, and
the anomaly classification comprises an indication that the potential application associated with the subset comprises the compromised application.

15. The network security system of claim 11, wherein:
the application-specific classifier model comprises a misadvertising model trained to detect communications presented by malware that identify as originating from the application, and
the anomaly classification comprises an indication that the subset of HTTP traffic comprises the communications presented by malware that identify as originating from the known application.

16. The network security system of claim 11, wherein to batch the subset of the HTTP traffic based on the user-agent information, the profiling engine is further configured to batch the subset of the HTTP traffic based at least in part on a time window associated with the subset.

17. The network security system of claim 11, wherein the network traffic behavioral profile comprises pre-identified patterns of network traffic behavior associated with HTTP traffic attributed to known the application.

18. The network security system of claim 11, wherein to apply the security policy, the security policy enforcer is configured to:
block transmission of a portion of the HTTP traffic associated with the endpoint device,
block transmission of a portion of the HTTP traffic associated with the potential application,
modify a device score for the endpoint device,
modify an application score for the potential application,
blacklist the endpoint device,
blacklist the potential application,
or a combination thereof.

19. The network security system of claim 11, further comprising a training engine configured to:
batch training subsets of the HTTP traffic, wherein the training subsets are selected based at least in part on the known application identified based on the user-agent information of the training subsets; and
train the application-specific classifier model using the header information of the training subsets in combination with the user-agent information of the training subsets to establish the network traffic behavioral profile corresponding to the known application.

20. One or more non-transitory computer-readable storage media having program instructions stored thereon that, when read and executed by one or more processors of a computing device, direct the computing device to at least:
intercept hypertext transfer protocol (HTTP) traffic between endpoint devices and destination domain servers, wherein the computing device is interposed between the endpoint devices and the destination domain servers;
extract header information including user-agent information from each HTTP request and each HTTP response of the HTTP traffic;
batch a subset of the HTTP traffic, wherein the subset is selected based at least in part on an endpoint device of the endpoint devices identified based on the header information and a potential application executing on the endpoint device identified based on the user-agent information, wherein the potential application corresponds to a known application;
select, from a plurality of application-specific classifier models, an application-specific classifier model associated with the known application, wherein the application-specific classifier model is trained to identify network traffic behavior of the potential application that is inconsistent with network traffic behavior of the known application based on a network traffic behavioral profile corresponding to the known application;
determine the network traffic behavior of the potential application is inconsistent with the network traffic behavior of the known application based on an application of the application-specific classifier model to the subset, wherein to determine whether the network traffic behavior of the potential application is inconsistent with the network traffic behavior of the known application, the program instructions further direct the computing device to:
generate, by the application-specific classifier model, an anomaly classification based on comparing the header information of the subset in combination with the user-agent information of the subset to the network traffic behavioral profile; and
apply a security policy to future HTTP traffic associated with the endpoint device and the potential application based at least in part on the anomaly classification, wherein:
the program instructions directing the computing device to apply the security policy further direct the computing device to perform a security action on the future HTTP traffic to limit future damage caused by the future HTTP traffic, and
the security action comprises blocking at least a portion of the future HTTP traffic.
